(19) United States
(12) Patent Application Publication
(10) Pub. No.: US 2002/0077145 A1
(43) Pub. Date: Jun. 20, 2002

(54) Foldable cellular phone

(75) Inventors: Shinichi Kamiya, Shizuoka (JP); Masataka Suzuki, Shizuoka (JP)

Correspondence Address: OSTROLENK FABER GERB & SOFFEN, 1180 AVENUE OF THE AMERICAS, NEW YORK, NY, 100368403

(73) Assignee: NEC Corporation

(21) Appl. No.: 10/015,325

(22) Filed: Dec. 13, 2001

(30) Foreign Application Priority Data
Dec. 14, 2000 (JP) 380400/2000

(51) Int. Cl. H04M 1/00

(52) U.S. Cl. 455/550; 455/566

(57) ABSTRACT

A foldable cellular phone of the present invention includes a first casing including a display and a second casing including keys and hinged to the first casing. A third casing accommodates a camera unit and a receiver unit therein and is received in a bore, which is formed in one end of the first casing, and rotatably connected to the first casing. The third casing is configured such that when the output portion of the receiver unit faces the display side of the first casing, the lens portion of the camera unit is concealed by the above end of the first casing. In a phone mode, as distinguished from a TV (television phone) phone mode, the lens portion of the camera unit is not exposed to the outside and is therefore free from direct contact with the user's face or ear.

### BACKGROUND OF THE INVENTION

1. Field of the Invention

The present invention relates to a foldable cellular phone of the type including a camera unit and more particularly to a foldable cellular phone capable of protecting the lens portion of its camera unit from contamination and scratches.

2. Description of the Background Art

It is a common practice with a foldable cellular phone with a camera unit to position the camera unit such that its lens portion appears on the casing of phone above a display. The phone with this configuration conceals the lens portion of the camera unit when folded, protecting the lens portion from contamination and scratches. However, when the user of the phone is conversing on the phone after unfolding it, the lens portion of the camera unit is exposed to the outside. In this condition, it is likely that the user's face, ear or hair contacts the lens portion and contaminates it with oil or scratches it.

Technologies relating to the present invention are disclosed in, e.g., Japanese Patent Laid-Open Publication Nos. 8-294030, 10-65780, 2000-197026 and 2000-201335 and Japanese Patent No. 3,059,841.

### SUMMARY OF THE INVENTION

It is an object of the present invention to provide a foldable cellular phone allowing its camera unit to readily show itself when used or protecting it from contamination and scratches when not used.

A foldable cellular phone of the present invention includes a first casing including a display and a second casing including keys and hinged to the first casing. A third casing accommodates a camera unit and a receiver unit therein and is received in a bore, which is formed in one end of the first casing, and rotatably connected to the first casing. The third casing is configured such that when the output portion of the receiver unit faces the display side of the first casing, the lens portion of the camera unit is concealed by the above end of the first casing.

### BRIEF DESCRIPTION OF THE DRAWINGS

The above and other objects, features and advantages of the present invention will become more apparent from the following detailed description taken with the accompanying drawings in which:

FIG. 1 is an isometric view showing a foldable cellular phone embodying the present invention in an unfolded position with a camera unit being not used;

FIG. 2 is a view similar to FIG. 1, showing the cellular phone in the unfolded position with the camera unit being used:

FIG. 3 is an isometric view showing the cellular phone in a folded position;

FIG. 4 is an exploded isometric view showing the cellular phone;

FIG. 5 is a fragmentary section showing a rotary body included in the illustrative embodiment in a condition in which the camera unit is not used; and

FIG. 6 is a view similar to FIG. 5, showing the rotary body in a condition in which the camera unit is used.

### DESCRIPTION OF THE PREFERRED EMBODIMENT

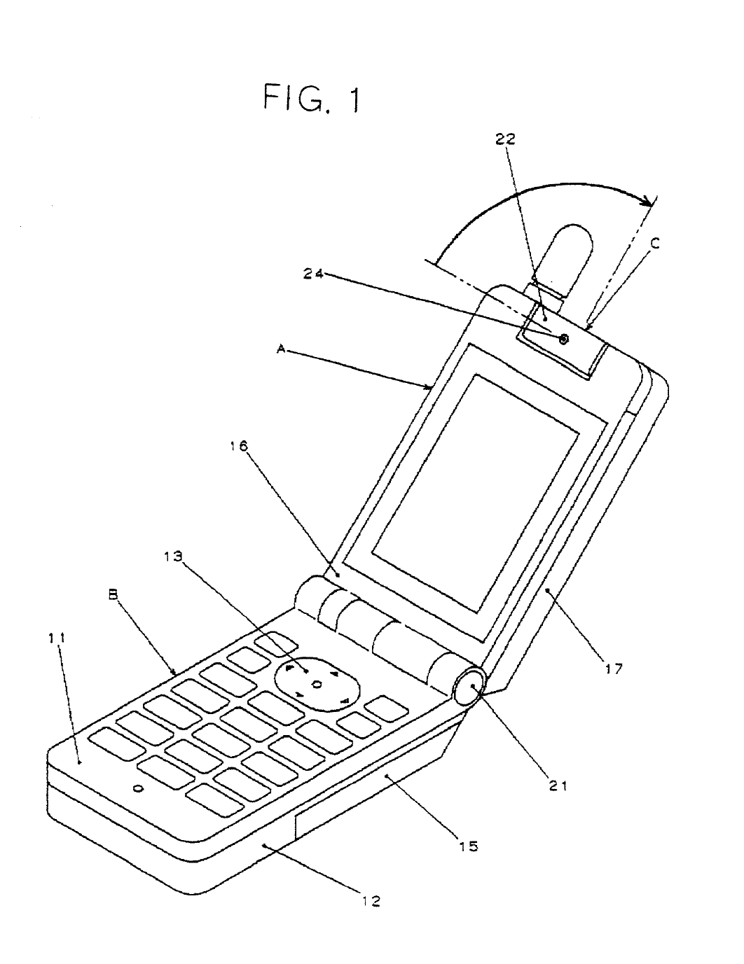

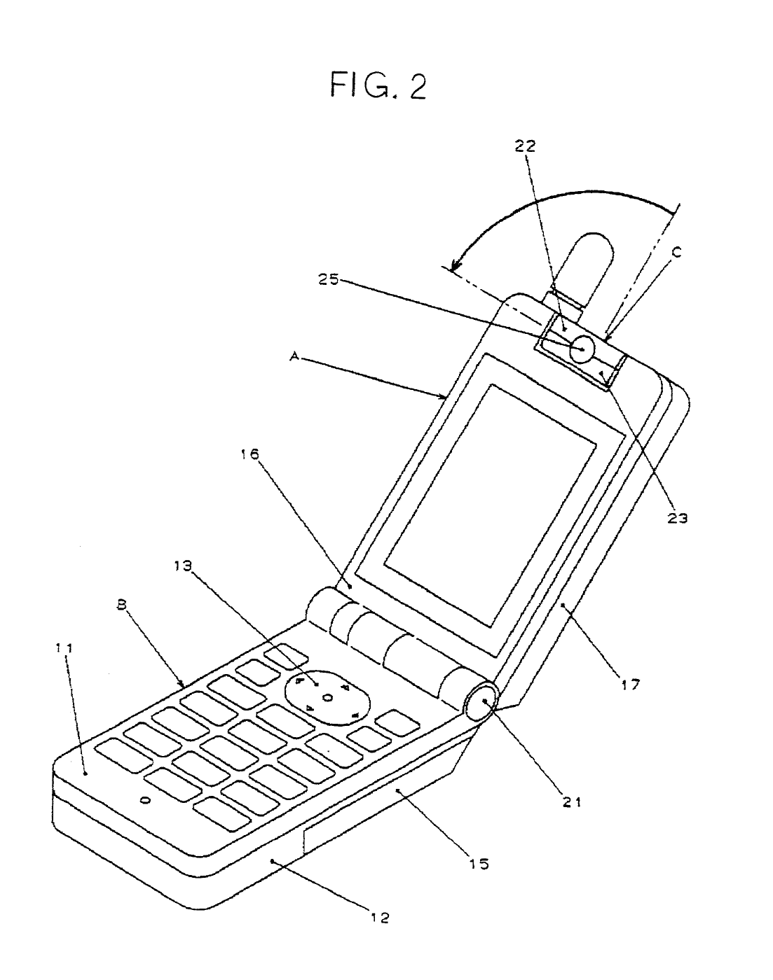

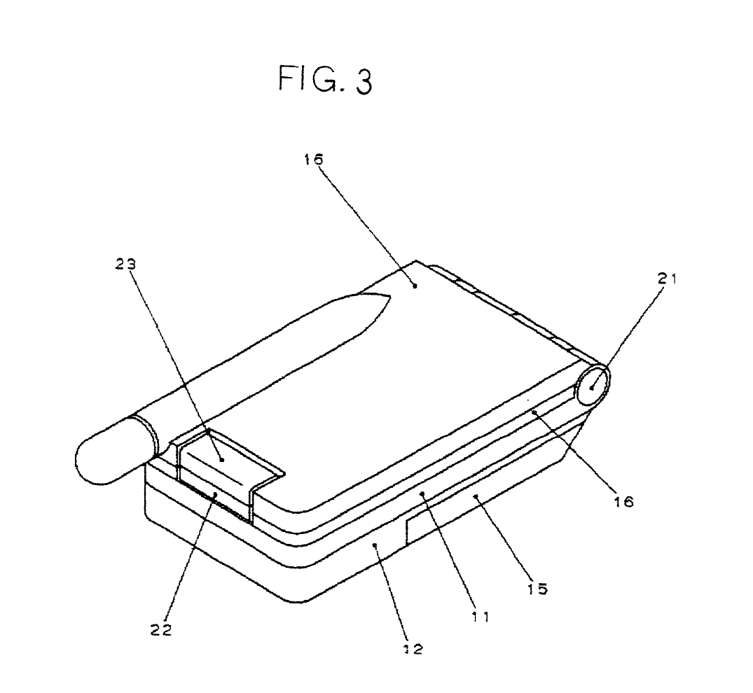

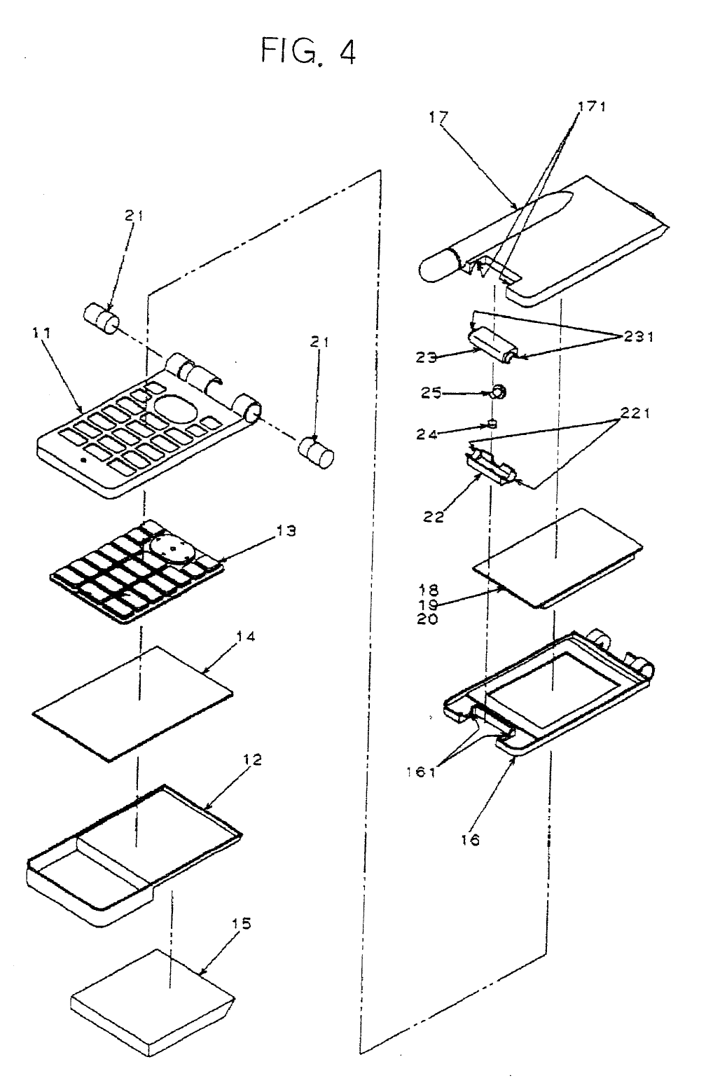

Referring to FIGS. 1 through 4, a foldable cellular phone embodying the present invention is shown. As shown, the phone includes a camera unit 25. FIG. 1 shows the phone in an unfolded position with the camera unit 25 being not used. FIG. 2 shows the phone in the unfolded position with the camera unit 25 being used. FIG. 3 shows the phone in a folded position. Further, FIG. 4 shows the construction of the phone in an exploded isometric view.

The phone is generally made up of a display section A, an operation section B. and a rotatable body C. The display section A and operation section B are connected to each other by a hinge unit 21, so that the phone is unfoldable.

The display section A includes a casing or first casing made up of a display front case 16 on which an LCD (Liquid Crystal Display) 19 is mounted and a display rear case 17 expected to face the user's hand. The casing accommodates a display circuit board 18. The LCD 19 is supported by an LCD frame 20. An antenna is received in an antenna storing portion included in the display rear case 17. More specifically, as shown in FIG. 3, the antenna storing portion has a convex wall protruding from the display rear case 17 at the left-hand side of the case 17. The tip of the antenna protrudes from the antenna storing portion above the LCD 20. The rotatable body C is received in a bore formed at substantially the center of the end of the casing above the LCD 19.

The operation section B includes a casing or second casing made up of an operation front case 11 on which various keys arranged and an operation rear case 12 expected to face the user's hand. The casing accommodates a key sheet 13 and an operation circuit board 14. A battery 15 is removably received in a battery storing portion included in the operation rear case 12.

The rotary body C includes a casing or third casing made up of a rotation front case 22 and a rotation rear case 23. The rotary body C accommodates a receiver unit 24 and the camera unit 25 mentioned earlier. The output portion of the receiver unit 24 and the lens portion of the camera unit 25 are positioned on the outer periphery of the casing and oriented in different directions from each other. In the illustrative embodiment, the output portion of the receiver unit 24 and the lens portion of the camera unit 25 are angularly spaced from each other by about 90°. The rotary body C has shaft portions 221 and 231 at opposite ends thereof. The shaft portions 221 and 231 are respectively rotatably supported by bearings 161 and 171, which are positioned on the walls of the bore of the casing of the display section A facing each other.

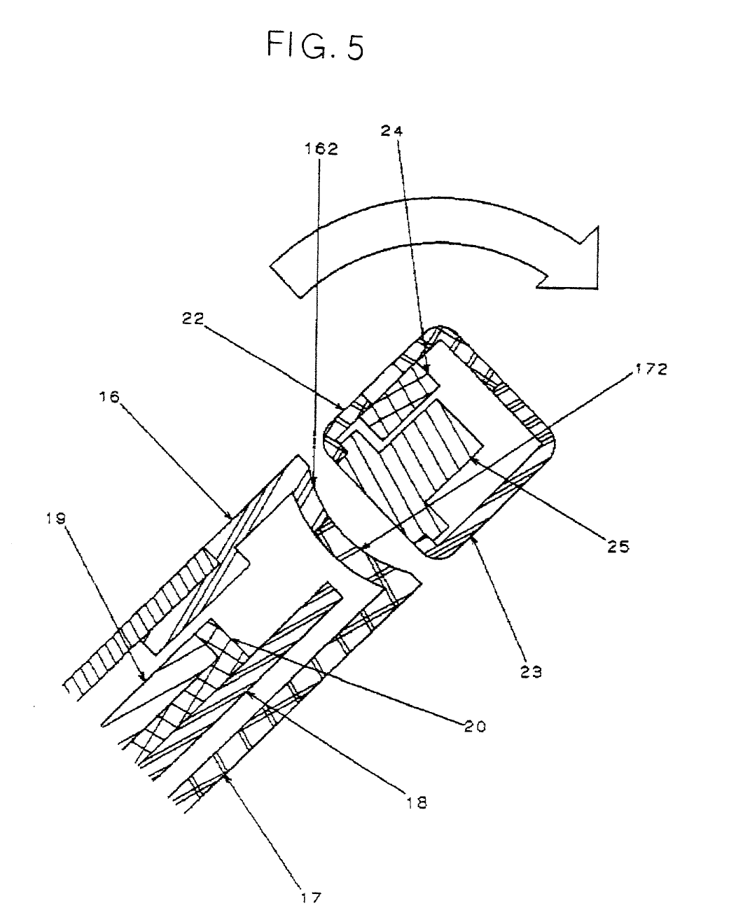

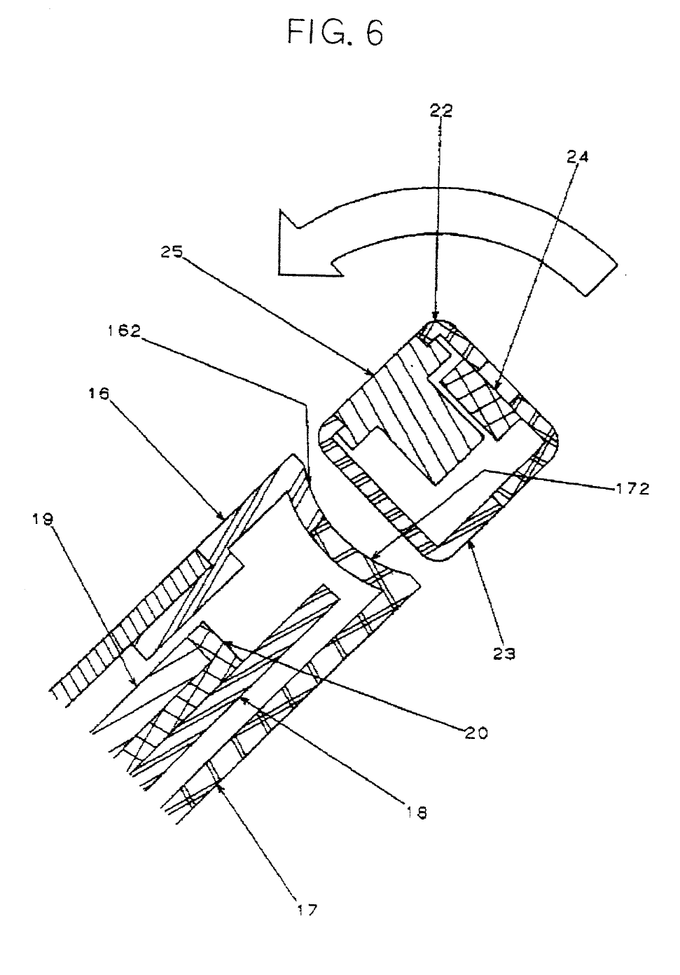

Conditions in which the user of the phone is expected to use the phone will be described hereinafter. FIG. 5 shows the phone with the camera unit 25 being not used while FIG. 6 shows it with the camera unit 25 being used. As shown in FIG. 5, to operate the phone in a usual phone mode, the user unfolds the phone and then rotates the rotary body C in a direction indicated by an arrow such that the output portion of the receiver unit 24 faces the front side of the phone, i.e., the side where the LCD 20 is positioned. At this instant, the lens portion of the camera unit 25 faces the end 162 of the display front case 16 and the end 172 of the display rear side 17. In this condition, the user uses the phone by putting the output portion of the receiver unit 24 on the user's ear.

As shown in FIG. 6, to operate the phone in a TV (television) phone mode, the user rotates the rotary body C in a direction indicated by an arrow such that the lens portion of the camera unit 25 faces the front side of the phone. The user then puts the phone on, e.g., a table and uses the phone in a hands-free fashion.

It will be seen that in the phone mode the lens portion of the camera unit 25 is not exposed to the outside and is therefore free from direct contact with the user's face, ear or hair. This successfully protects the lens portion of the camera unit 25 from contamination and scratches and protects it from damage when the phone is let fall by accident.

While the rotary body C of the illustrative embodiment is rotatable about a horizontal axis, it may alternatively be configured to rotate about a vertical axis.

Various modifications will become possible for those skilled in the art after receiving the teachings of the present disclosure without departing from the scope thereof.

What is claimed is:

1. A foldable cellular phone comprising:
a first casing including a display;
a second casing including keys and hinged to said first casing; and
a third casing accommodating a camera unit and a receiver unit therein and received in a bore, which is formed in one end of said first casing, and rotatably connected to said first casing;
wherein said third casing is configured such that when an output portion of said receiver unit faces a display side of said first casing, a lens portion of said camera unit is concealed by the one end of said first casing.

2. The phone as claimed in claim 1, wherein said bore is positioned at substantially a center of said first casing above said display, and said third casing is rotatable about a vertical axis within said bore.
